(19) United States
(12) Patent Application Publication
(10) Pub. No.: US 2006/0248996 A1
(43) Pub. Date: Nov. 9, 2006

(54) Device and process for cutting continuous modules

(75) Inventor: Francesco Valentinis, Chiaverano (IT)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: CEM S.p.A., Trezzano Sul Naviglio (IT)

(21) Appl. No.: 11/410,987

(22) Filed: Apr. 26, 2006

(30) Foreign Application Priority Data
May 4, 2005 (IT) MI 2005 A 000809

(51) Int. Cl. B26D 5/20

(52) U.S. Cl. 83/202; 83/225

(57) ABSTRACT

The device for cutting continuous modules comprises means for feeding said continuous modules to cutting means arranged to cut said continuous modules in order to form a plurality of sheets of predetermined dimensions. The cutting means comprise two or more cutting units arranged to cut the continuous modules to simultaneously form two or more sheets of predetermined dimensions. The process for cutting continuous modules consists of feeding the continuous modules to cutting means and cutting the continuous modules to form a plurality of sheets of predetermined dimensions. Advantageously a plurality of transverse cuts are made simultaneously, to simultaneously form two or more sheets of predetermined dimensions.

The present invention relates to a device and process for cutting continuous modules; particular reference will be made hereinafter to a device and process of intermittent cycle operation, used for feeding binding and envelope filling machines.

Documents are known to be printed (by a suitable printer) on continuous paper modules which are then cut into sheets of predetermined dimensions to form documents; these sheets are then bound (to form the document) and inserted into envelopes, to be sent to the addressees.

The current tendency is to construct binding and envelope filling machines of ever increasing speed; consequently the speed of the device for cutting the continuous modules (which receives the continuous modules, cuts them and feeds them to the binding or envelope filling machine) has to increase to maximize productivity by maintaining the downstream devices always saturated (i.e. operating at maximum productivity).

Traditional cutting devices comprise an element for transporting a continuous module to a cutting unit, which cuts the continuous module to form the sheets to be fed to the binding or envelope filling machine. Specifically, as the cut has necessarily to be made with the sheet at rest, the continuous module is advanced, halted, the cut made, and the continuous module again advanced to prepare it for the next cut.

To increase productivity, it has been sought to decrease the duration of the advancement stage by increasing the acceleration and the maximum speed with which the module is made to advance.

However, this implies an increase in the stresses acting on the continuous module, on the mechanical members of the transport element and on the cutting device overall, in particular because of the vibrations generated; hence the productivity increase attainable in this manner is very limited.

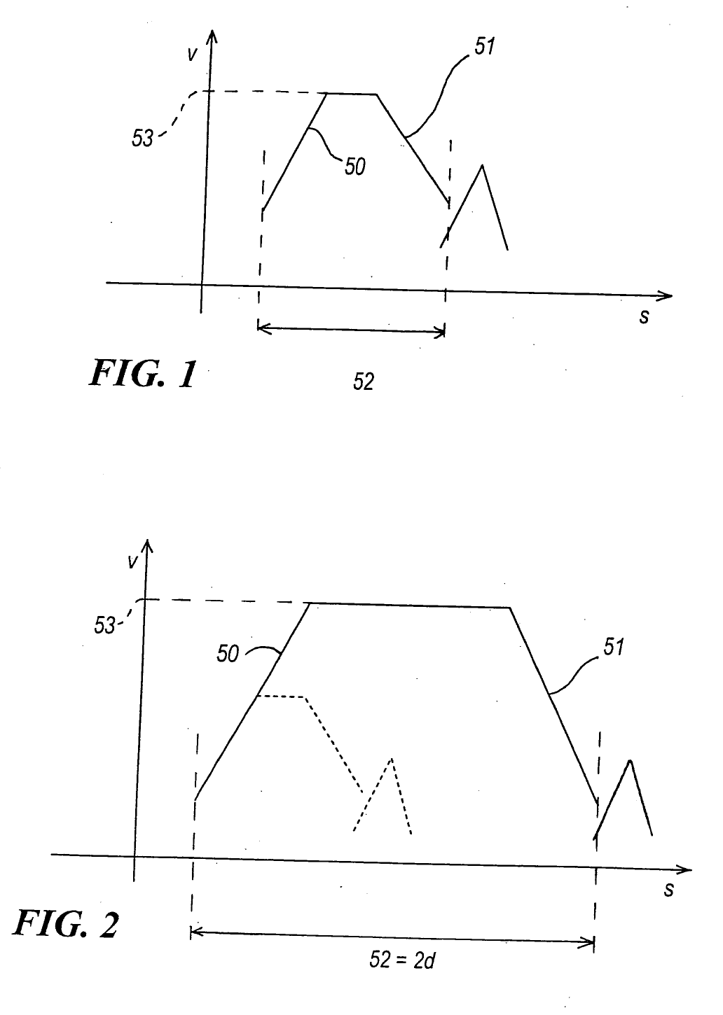

It was then sought to further increase productivity by partially superposing the transport and cutting stages (as shown in FIG. 1); in this respect, as the module to be cut need to be held at rest only when the blade is effectively cutting it, the continuous module can be moved into its required position for cutting while the blade itself begins to move but before it reaches the module.

However, even in this manner the attainable productivity increase is limited and inadequate for the speed of current binding and envelope filling machines.

Further productivity increases are not attainable using traditional means, because any acceleration increase in the continuous module, for the purpose if reaching higher maximum speeds, would too highly stress the continuous module and the machine members, with possible breakage.

It is also not possible to increase the duration of the acceleration and deceleration stages because these are necessarily limited by the space through which the continuous module has to travel and which is equal to the dimension of the sheet to be obtained (i.e. to be separated by cutting the continuous module) on the basis of the travelled space.

FIG. 1 is a diagram of speed against space travelled, showing the speed of the continuous module and of a blade which cuts the continuous module.

From this diagram it can be seen that the acceleration and deceleration ramp 50, 51 of the paper module is limited by the space to be travelled 52, the slope of the ramps being limited by the maximum acceleration to which the continuous module can be subjected; consequently the maximum speed 53 of the paper module is also limited.

The technical aim of the present invention is therefore to provide a device and process for cutting continuous modules by which the aforesaid technical problems of the known art are eliminated.

Within the scope of this technical aim, an object of the invention is to provide a device and process which enable a productivity, in terms of quantity of sheets separated (cut off) from the continuous module, to be achieved which is very high, and in particular much higher than that achievable with traditional devices.

Another object of the invention is to provide a device and process which, notwithstanding the high productivity obtained, do not excessively stress the continuous module or the overall device to a damaging extent.

Advantageously, the device and process of the present invention enable productivity to be increased compared with traditional devices, without substantially increasing the stresses to which the continuous module and the device members are subjected.

The technical aim, together with these and further objects, are attained according to the present invention by a device and process for cutting continuous modules in accordance with the accompanying claims.

Further characteristics and advantages of the invention will be more apparent from the description of a preferred but non-exclusive embodiment of the device and process of the invention, illustrated by way of non-limiting example in the accompanying drawings, in which FIG. 1 is a diagram representing the relationship between speed and movements of the continuous module and the blade of the cutting unit of a traditional device;

FIG. 2 is a diagram representing the relationship between speed and movements of the continuous module and the blades of the cutting units of a device according to the invention (in full lines) and of a traditional device (in dashed lines);

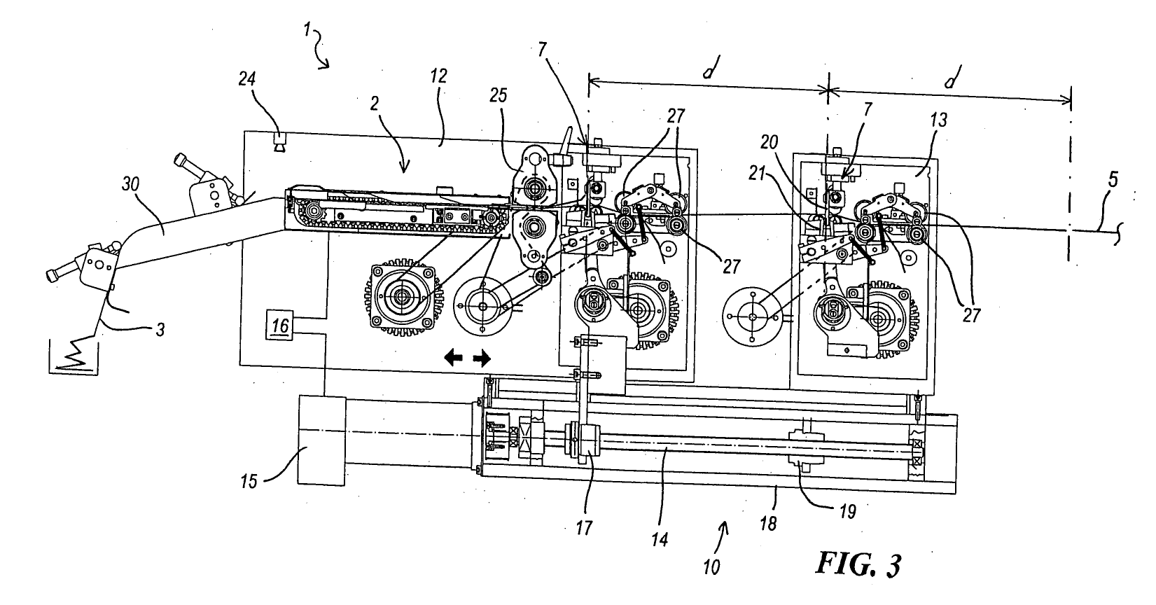

FIG. 3 is a schematic view of a device according to the present invention;

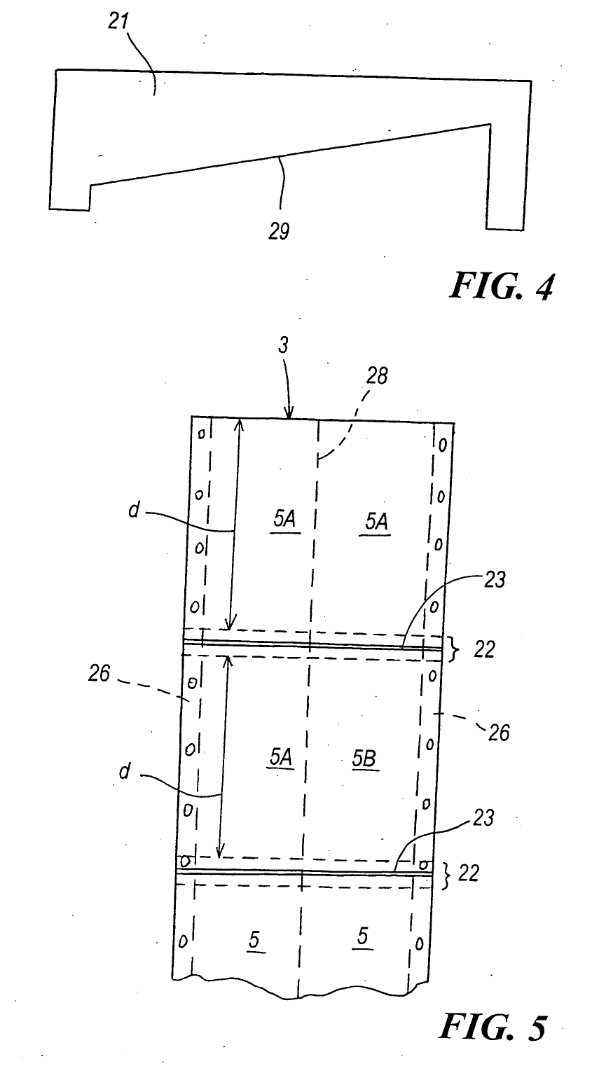

FIG. 4 is a front view of the cutting part of a blade; and

FIG. 5 is a view from above showing a continuous module to be cut.

Said figures show a device for cutting continuous modules, which is indicated overall by the reference numeral 1.

The device 1 comprises means 2 for feeding the continuous modules 3 to cutting means.

These feed means 2 consist of a dragging conveyor of pin or roller type.

The cutting means are arranged to cut the continuous modules 3 to form a plurality of sheets 5 of predetermined dimensions.

Advantageously, the cutting means comprise two or more cutting units 7, arranged to cut the continuous modules 3 to simultaneously form two or more sheets 5 of predetermined dimensions.

The device 1 also comprises means 10 for regulating the cutting distance “d”, i.e. the distance between two successive cuts made by two successive cutting units 7.

As shown in the accompanying figures, each cutting unit 7 is supported by a first and a second support 12, 13 which are movable relative to each other.

Specifically, the regulator means 10 comprise a spacer 14 interposed between the first and second support 12, 13 to define the position of the second support 13 relative to the first 12.

In a first embodiment, the spacer 14 comprises an actuator 15 connected to a processor 16 for controlling the device 1.

For example, the first support 12 is connected to a first lead nut 17, the second support 13 being connected, via an enclosure 18, to a second lead nut 19.

Both the lead nuts 17, 19 engage the spacer 14, consisting of a threaded bar; the thread engagements are suitably such that rotating the threaded bar (driven by the actuator 15 consisting for example of an electric motor) results in mutual withdrawal or approach of the lead nuts 17, 19 and hence of the two supports 12, 13 connected to them.

In a different embodiment, the spacer 14 comprises a mechanism provided with a screw, a lead nut and an operating handwheel.

For example, the mechanism can be as already described, but the actuator be replaced by a handwheel for driving the threaded bar; the handwheel is not shown.

Advantageously, each of the cutting units 7 comprises blades 20 provided with a first and a second cutting part 21 which are spaced apart such that for each cutting operation, each blade 20 removes a transversal paper strip 22 of predetermined dimensions.

Removing the strip 22 results in elimination of that part of the continuous module along which the module is folded (transverse lines 23 of FIG. 5) when contained in its container (before being fed to the device of the invention).

The device 1 also comprises a sensor 24 for reading codes printed on the continuous module.

The sensor 24 is connected to the processor 16 controlling the device 1, such that the processor 16 controls the operation of the device 1 on the basis of the codes read by the sensor 24.

For example the codes can indicate those sheets 5 (to be separated) pertaining to a given document; in this case the processor 16 controls the device 1 such that it feeds to the binding and envelope filling device only those sheets 5 which form part of that document, and no others even though they may be printed (and generally they are printed) on the same continuous module.

The device 1 can also present a circular trimmer 25 for removing the perforated lateral bands 26 of the continuous paper module 3, which were necessary to enable the dragging conveyor (of pin type) to grip the continuous module 3 and advance it.

The device can also present further circular trimmer for longitudinal removing (cut) of modules when they are printed on multiple side-by-side columns.

The device is also provided with a plurality of rollers 27 for deviating and supporting the paper module 3.

FIG. 4 shows a cutting part 21 of a blade 20; as shown, the cutting part presents an oblique edge 29, such that when it is lowered onto the continuous module 3, the continuous module is not cut simultaneously along its entire length, but is cut first at one end (that at which the blade height is greatest) and then along the rest of its length, in relation to when the cutting parts 21 are lowered onto the continuous module.

This has proved to be very useful, because when numerous documents are printed on the same continuous module (FIG. 5), the sensor 24 transmits to the processor the codes read on the continuous module 3, enabling the processor to operate the cutting units 7 such that they lower the blades 20 (and the cutting parts 21 which they carry) and cut the continuous module to separate only those sheets forming part of the same document, and no others; in this manner only the sheets of a particular document are fed to the binding and envelope filling device.

For example, FIG. 5 shows the continuous module 3 on which the document 5A and the document 5B are printed; the cutting operations hence consist of an initial cut extending along the entire transverse dimension of the continuous module, to separate the first two sheets 5A of the document, and then a second cut contemporaneous to the first cut and partial to separate the third sheet 5A of the same document.

The operation of the cutting device for continuous modules according to the invention is apparent from that described and illustrated, and is substantially as follows.

Firstly, the dimensions of the sheets 5 to be formed have to be set, these dimensions being equal to the distance “d”.

The distance “d” is set via the processor 16; the processor 16 operates the actuator 15, which drives the spacer 14 by rotating it until the cutting units 7 lie at the required distance apart “d”.

The continuous paper module 3 is then inserted into the dragging conveyor 2, after suitably inserting it into a guide -member 30 which facilitates its approach to the device and in particular to the conveyor 2.

When the device is operated, the conveyor 2 drags the sheet and advances it towards the circular trimmer 25 and the cutting units 7.

In practice, the continuous paper module 3 is advanced through a predetermined distance and then again halted to be cut to remove the strips 22.

In the present embodiment, two cutting units 7 are provided, the module 3 being made to advance by a distance equal to double the distance “d” (plus the distance required to compensate the strips 22 to be removed); in other embodiments however, the device can present more than two cutting units, the module 3 being made to advance by a distance equal to the number of cutting units 7 multiplied by the distance “d”, representing the dimension of each individual sheet to be separated from the continuous module 3 (plus the distance required to compensate the strips 22 to be removed).

Longitudinal cuts 28 are also made in known manner to separate the required sheets 5.

The separated sheets 5 are then fed to the binding and envelope filling device.

Advantageously, the fact of advancing the continuous module by a distance equal to double the distance “d” enables maximum advancement speeds to be attained which are higher than that possible with traditional devices, hence reducing overall advancement times.

For example, FIG. 2 shows that the maximum speed attained by the device of the invention (full line) is greater than the maximum speed attained by traditional devices (dashed line) even though maintaining the same accelerations in the two cases (i.e. with the acceleration ramp 50 and deceleration ramp 51 presenting the same slope both in the device of the invention and in traditional devices).

A further productivity increase is ensured by the simultaneity of several cutting operations; specifically, the described device makes two cuts (and consequently separates two sheets from the continuous module) in a single cutting cycle, i.e. with a single stoppage of the continuous module.

The present invention also relates to a process for cutting continuous modules.

This process consists of feeding the continuous modules 3 to cutting means and cutting the continuous modules 3 to form a plurality of sheets 5 of predetermined dimensions.

Advantageously, a plurality of transverse cuts are made simultaneously, to simultaneously obtain two or more sheets 5 of predetermined dimensions.

The cutting distance “d” is suitably regulated, to vary the dimensions of the formed sheets.

A code printed on pages defined by the continuous module is read and a value indicative of the read code is transmitted to an electronic processor which controls the cutting operations on the basis of the read code.

It has been found in practice that the device and process for cutting continuous modules according to the invention are particularly advantageous as they enable very high productivity to be achieved (to adapt the speed of the cutting devices to that of the binding and envelope filling devices) without however exerting high stresses (and in particular higher stresses than those of traditional devices) on the continuous module to be cut or on the overall device.

The device and process for cutting continuous modules conceived in this manner are susceptible to numerous modifications and variants, all falling within the scope of the inventive concept; moreover all details can be replaced by technically equivalent elements.

In practice the materials used and the dimensions can be chosen at will in accordance with requirements and with the state of the art.

1. A device for cutting continuous modules, comprising means for feeding said continuous modules to cutting means arranged to cut said continuous modules in order to form a plurality of sheets of predetermined dimensions, characterised in that said cutting means comprise two or more cutting units arranged to cut said continuous modules to simultaneously form two or more of said sheets of predetermined dimensions.

2. A cutting device as claimed in claim 1, characterised by comprising means for regulating the cutting distance operated by said cutting units.

3. A cutting device as claimed in one or more of the preceding claims, characterised in that said cutting units are supported by at least one first and one second support, which are movable relative to each other.

4. A cutting device as claimed in one or more of the preceding claims, characterised in that said regulator means comprise a spacer interposed between said first and second support, to define the position of the second support relative to the first.

5. A cutting device as claimed in one or more of the preceding claims, characterised in that said spacer comprises an actuator connected to a device control processor.

6. A cutting device as claimed in one or more of the preceding claims, characterised in that said spacer comprises a mechanism provided with a screw, lead nut and operating handwheel.

7. A cutting device as claimed in one or more of the preceding claims, characterised in that each of said cutting units comprises blades provided with a first and a second cutting part which are spaced apart such that for each cutting operation, each of said blades removes a paper strip of predetermined dimensions.

8. A cutting device as claimed in one or more of the preceding claims, characterised by comprising a sensor for reading a code printed on pages defined by said continuous module, said sensor being connected to an electronic control processor for said device, such that said processor controls the operation of said machine on the basis of said codes read by said sensor.

9. A process for cutting continuous modules, consisting of feeding the continuous modules to cutting means and cutting the continuous modules to form a plurality of sheets of predetermined dimensions, characterised by simultaneously making a plurality of transverse cuts to simultaneously form two or more sheets of predetermined dimensions.

10. A cutting process as claimed in the preceding claim, characterised by regulating the cutting distance in order to vary the dimension of the sheets formed.

11. A cutting process as claimed in one or more of the preceding claims, characterised by reading a code printed on pages defined by the continuous module, and transmitting a value indicative of the read code to an electronic processor which controls the cutting operations on the basis of the code read.
